(19) United States
(12) Patent Application Publication
(10) Pub. No.: US 2007/0242192 A1
(43) Pub. Date: Oct. 18, 2007

(54) Color filter substrate for liquid crystal display and method of fabricating the same

(75) Inventors: Se Jong Shin, Daegu (KR); Bong Chul Kim, Daegu (KR); Tae Hyung Lee, Daegu (KR); Hong Myeong Jeon, Gyeongsangbuk-do (KR); Jun Kyu Park, Gyeonggi-do (KR)

Correspondence Address: SEYFARTH SHAW, LLP, 815 CONNECTICUT AVENUE, N.W., SUITE 500, WASHINGTON, DC, 20006, US

(73) Assignee: LG.PHILIPS LCD CO., LTD., Seoul (KR)

(21) Appl. No.: 11/645,734

(22) Filed: Dec. 27, 2006

(30) Foreign Application Priority Data
Apr. 14, 2006 (KR) 10-2006-0034169

(51) Int. Cl. G02F 1/1335

(52) U.S. Cl. 349/106

(57) ABSTRACT

A color filter substrate for a liquid crystal display includes a transparent insulating substrate, a black matrix shape on the transparent insulating substrate defining sub-pixel regions, a barrier of transparent material on the black matrix shape, and color filters in the sub-pixel regions, wherein the black matrix shape has a first thickness, the barrier has a second thickness, and each of the color filters have a third thickness.

This application claims the benefit of Korean Patent Application No. 2006-0034169 filed on Apr. 14, 2006, which is hereby incorporated by reference in its entirety.

### BACKGROUND OF THE INVENTION

1. Field of the Invention

Embodiments of the invention relate to a display device, and more particularly, to a color filter substrate for a liquid crystal display (LCD) and a method of manufacturing the same.

2. Background of the Related Art

In today's information-oriented society, electronic display devices play very important roles in daily life. Various electronic display devices are widely used in various industrial fields. Electronic display devices having new functions suitable for the various needs of information-oriented society are continuously being developed.

In general, the electronic display devices transmit information items to human beings through eyesight. That is, the electronic display devices convert electronic information signals output various electronic apparatuses into optical information signals that can be recognized by human eyesight to form a conduit between the human beings and the electronic apparatus. When the optical information signals are displayed in the electronic display devices by an emission phenomenon, the electronic display device is referred to as emission type display devices. When the optical information signals are displayed in the electronic display device by optical modulation, reflection, scattering, and/or an interference phenomena, the electronic display device is referred to as light receiving type display devices.

The emission type display devices include a cathode ray tube (CRT), a plasma display panel (PDP), an organic electroluminescent display (OELD), and a light emitting diode (LED). The emission type display devices are also referred to as active display devices. The light receiving type display devices include a liquid crystal display (LCD) and electrophoretic image display (EPID). The light receiving type devices are also referred to as passive display devices.

Display devices are used in televisions, computer monitors and the like. The CRT is the oldest display device and has been the most commonly used display device. However, the CRT has many disadvantages, such as being heavy, voluminous, and having high power consumption.

Due to the rapid development of semiconductor technologies, electronic devices with low operating voltages and low power consumption have been developed. Different types of flat panel displays (FPD), which are small, thin, and lightweight, have been developed using these types of semiconductor devices. Such FPDs include the LCD, the PDP, and the OELD. Among the FPDs, the LCD has the lowest power consumption and the lowest driving voltage.

In the LCD, a liquid crystal material having an anisotropic dielectric constant is implanted between a color filter substrate on which color filters and a black matrix shape are formed and an array substrate on which thin film transistors (TFT) and pixel electrodes are formed. Different electric potentials are applied to the pixel electrodes and a common electrode so that the intensity of electric field formed across the liquid crystal material is controlled to change the arrangement of the molecules in the liquid crystal material. Therefore, the amount of light that passes between the color filter substrate and the array substrate is controlled by the arrangement of the molecules in the liquid crystal material to display a desired image.

To reduce processes of manufacturing the color filter substrate for the LCD, a black resin that absorbs light is used for forming the black matrices. When the black matrices are formed using a black resin that absorbs light, it is difficult to form the black matrix shape accurately with enough thickness to contain ink-jetted color filters. In other words, when barriers are not formed on a black resin in a black matrix shape, the red color filters, the green color filters, and the blue color filters that are formed in the black matrix shape may mix with each other. Such a problem is more severe when the color filters are formed by an inkjet spray method. Thus, barriers are formed on the black resin in a black matrix shape. In the related art, such the barriers are formed after forming the black matrices using an additional photolithography process and an etching process. Therefore, the process of manufacturing the color filter substrate for the LCD becomes more complicated.

### SUMMARY OF THE INVENTION

Accordingly, embodiments of the invention is directed to a color filter substrate for a liquid crystal display (LCD) and a method of manufacturing the same that substantially obviate one or more of the problems due to limitations and disadvantages of the related art.

An object of embodiments of the invention is to provide a color filter substrate for a liquid crystal display (LCD) capable of simply forming a black matrix shape with a barrier thereon.

Another objective of embodiments of the invention is to provide a color filter substrate for an LCD capable of preventing color ink-jet material from overflowing out of sub-pixel regions when color filters are formed with an inkjet spray method.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To accomplish the above technical objective, there is provided a color filter substrate for a liquid crystal display includes a transparent insulating substrate, a black matrix shape on the transparent insulating substrate defining sub-pixel regions, a barrier of transparent material on the black matrix shape, and color filters in the sub-pixel regions, wherein the black matrix shape has a first thickness, the barrier has a second thickness, and each of the color filters have a third thickness.

In another aspect, a method of manufacturing a color filter substrate for a liquid crystal display includes forming a black matrix layer on a transparent insulating substrate, forming a barrier layer of a transparent photosensitive material on the black matrix layer, patterning the black matrix layer and the barrier layer to respectively form the black matrix shape that defines sub-pixel regions and the barriers, and forming color filters in the sub-pixel regions.

In yet another aspect, a color filter substrate for a liquid crystal display includes a transparent insulating substrate, a black matrix shape on the transparent insulating substrate and having a first thickness; a transparent barrier with a same shape as the black matrix shape and having a second thickness, and color filters having a third thickness and positioned within the black matrix and the transparent barrier, wherein the second thickness is at least as much as a difference between the first thickness and the third thickness.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention. In the drawings:

FIG. 1 is a cross-sectional view of a color filter substrate for a liquid crystal display (LCD) according to an embodiment of the invention; and

FIGS. 2A to 2D are cross-sectional views illustrating processes of manufacturing the color filter substrate for the liquid crystal display according to an embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

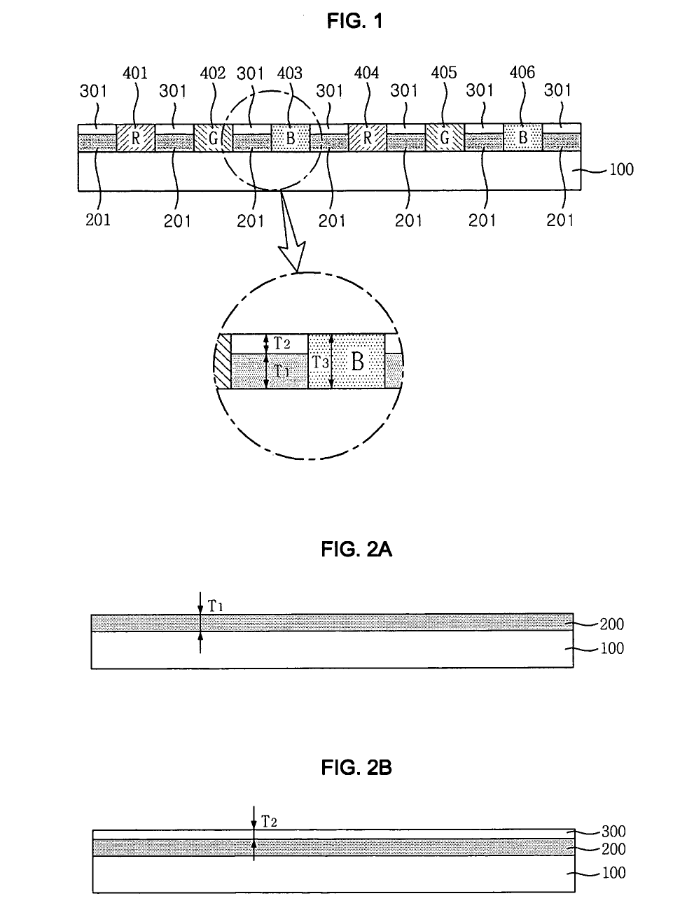

FIG. 1 is a cross-sectional view of a color filter substrate for a liquid crystal display (LCD) according to an embodiment of the invention. As illustrated in FIG. 1, the color filter substrate for the liquid crystal display device according to the embodiment of the invention includes a black matrix shape 201, a barrier 301 on the black matrix shape, and color filters 401 to 406.

The black matrix shape 201 is formed on a transparent insulating substrate 100, such as glass, to define sub-pixel regions. The black matrix shape 201 can be formed of a black resin that absorbs light and has a thickness T1 of about 1.0 μm to about 1.5 μm. The black matrix shape 201 is formed by a photolithography process, including an exposure process and a development process.

The barrier 301 can be formed from a transparent photosensitive material on the black matrix shape 201. Because the barrier 301 is formed of a transparent photosensitive material, the black matrix shape 201 and the barrier 301 can be simultaneously formed by the same photolithography process, including an exposure and development process. Thus, the manufacturing process of the color filter substrate for an LCD is simplified since the black matrix shape 201 and the barrier 301 can be simultaneously formed in the same process step. The barrier 301 can be formed to a thickness T2 of about 0.5 μm to about 1.0 μm, depending on the thickness T3 of a hardened layer of the colored ink that was sprayed into a sub-pixel to form the color filters 401 to 406. In other words, the thickness T2 of the barrier 301 at least as much as a difference between the thickness T3 of the color filters 401 to 406 and the thickness T2 of the black matrix shape 201 so as to contain the colored ink the was sprayed into a sub-pixel.

The color filters 401 to 406 include the red color filters 401 and 404 for red (R) sub-pixels to realize red, green color filters 402 and 405 for green (G) sub-pixels to realize green, and the blue color filters 403 and 406 for blue (B) sub-pixels to realize blue. The red color filters 401 and 404, the green color filters 402 and 405, and the blue color filters 403 and 406 are formed in the sub-pixel regions defined by the black matrix shape 201. More specifically, the red color filters 401 and 404, the green color filters 402 and 405, and the blue color filters 403 and 406 are alternately formed in the sub-pixel regions defined by the black matrix shape 201.

The thickness T3 of the color filters 401 to 406 is between about 8/10 to about 10/10 of the sum of the thickness T1 of the black matrix shape 201 and the thickness T2 of the barrier 301. Such a thickness T3 of the color filters 401 to 406 with respect to the combined thickness T2+T3 of the barrier 301 and the black matrix shape 201, prevents the colored ink from overflowing into other sub-pixel regions when the color filters 401 to 406 are formed in sub-pixel regions with an inkjet spray method. The barrier 301, along with the black matrix shape 201, contains the colored ink in the sub-pixel so that the colored ink can be hardened into a color filter. The barrier 301 is formed of a transparent photosensitive material so as to be able to form both the black matrix shape 201 and the barrier 301 at the same time.

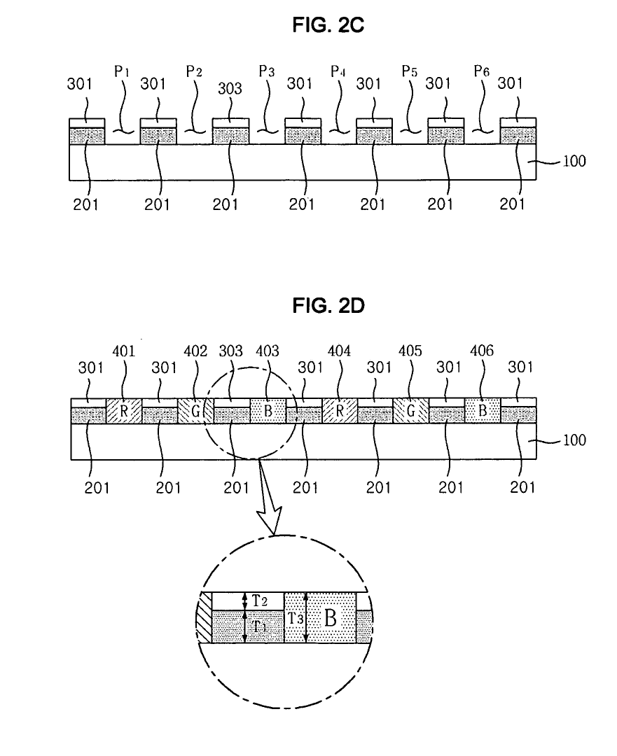

FIGS. 2A to 2D are cross-sectional views illustrating processes of manufacturing the color filter substrate for the liquid crystal display according to an embodiment of the invention. As illustrated in FIG. 2A, the transparent insulating substrate 100, such as glass, is coated with the black resin that absorbs light and is dried to form a black matrix layer 200. The black matrix layer 200 can be formed to a thickness of about 1.0 μm to about 1.5 μm.

Then, as illustrated in FIG. 2B, a barrier layer 300 of a transparent photosensitive material can be formed on the black matrix layer 200. For example, the barrier layer 300 is formed by a dry film method. More specifically, a poly ethylene terephthalate (PET) is coated with a transparent photosensitive material, such as a transparent photosensitive resin and then, the transparent photosensitive resin is transcribed onto the black matrix layer 200. The barrier layer 300 can be formed to a thickness T2 of about 0.5 μm to about 1.0 μm.

Then, as illustrated in FIG. 2C, the black matrix layer 200 and the barrier layer 300 are respectively patterned to form the black matrix shape 201 that define the sub-pixel regions P1 to P6 and the barrier 301. The black matrix layer 200 and the barrier layer 300 are patterned through a photolithography process, including an exposure and development process, so that the black matrix shape 201 and the barrier 301 are formed at the same time so that a photolithography process only occurs once. Thus, the black matrix layer 200 and the barrier layer 300 have the same shape.

Then, as illustrated in FIG. 2D, the red color filters 401 and 404 pixels to realize red, the green color filters 402 and 405 to realize green, and the blue color filters 403 and 406 to realize blue are formed in the sub-pixel regions P1 to P6 defined by the black matrix shape 201. The red color filters 401 and 404, the green color filters 402 and 405, and the blue color filters 403 and 406 are obtained by alternately spraying red color ink, green color ink, and blue color ink into the sub-pixel regions P1 to P6 by the inkjet spray method. Then, the colored inks are allowed to harden. Therefore, the red color filters 401 and 404, the green color filters 402 and 405, and the blue color filters 403 and 406 can be alternately formed in the sub-pixel regions P1 to P6.

The harden colored inks form color filters 401 to 406 that have a thickness T3 of about 8/10 to about 10/10 of the sum of the thickness T1 of the black matrix shape 201 and the thickness T2 of the barrier 301. Such a thickness T3 of the color filters 401 to 406 with respect to the combined thickness T2+T3 of the barrier 301 and the black matrix shape 201, prevents colored ink from overflowing to other sub-pixel regions when the color filters 401 to 406 are formed in sub-pixel regions with an inkjet spray method.

It will be apparent to those skilled in the art that various modifications and variations can be made in the of embodiments of the invention without departing from the spirit or scope of the invention. Thus, it is intended that embodiments of the invention cover the modifications and variations of this invention provided they come within the scope of the appended claims and their equivalents.

What is claimed is:

1. A color filter substrate for a liquid crystal display, comprising:
a transparent insulating substrate;
a black matrix shape on the transparent insulating substrate defining sub-pixel regions;
a barrier of transparent material on the black matrix shape; and
color filters in the sub-pixel regions,
wherein the black matrix shape has a first thickness, the barrier has a second thickness, and each of the color filters have a third thickness.

2. The color filter substrate of claim 1, wherein the black matrix shape and the barrier have the same shape.

3. The color filter substrate of claim 1, wherein the black matrix shape is formed of a black resin that absorbs light.

4. The color filter substrate of claim 1, wherein the first thickness is about 1.0 μm to about 1.5 μm.

5. The color filter substrate of claim 1, wherein the second thickness is about 0.5 μm to about 1.0 μm.

6. The color filter substrate of claim 1, wherein the second thickness is at least as much as a difference between the first thickness and the third thickness.

7. The color filter substrate of claim 1, wherein the third thickness is about 8/10 to about 10/10 of the sum of the first thickness and the second thickness.

8. A method of manufacturing a color filter substrate for a liquid crystal display, comprising:
forming a black matrix layer on a transparent insulating substrate;
forming a barrier layer of transparent photosensitive material on the black matrix layer;
patterning the black matrix layer and the barrier layer to respectively form the black matrix shape that defines sub-pixel regions and the barriers; and
forming color filters in the sub-pixel regions.

9. The method of claim 8, wherein the patterning the black matrix layer and the barrier layer includes a single photolithography process that patterns both the black matrix layer and the barrier layer.

10. The method of claim 8, wherein the black matrix layer is formed of a black resin that absorbs light.

11. The method of claim 8, wherein the black matrix layer has a thickness of about 1.0 μm to about 1.5 μm.

12. The method of claim 8, wherein the forming the barrier layer includes a dry film method.

13. The method of claim 8, wherein a second thickness of the barrier layer is at least as much as a difference between a first thickness of the black matrix shape and a third thickness of each of the color filters.

14. The method of claim 8, wherein the barrier layer has a thickness of about 0.5 μm to about 1.0 μm.

15. The method of claim 8, wherein the forming color filters includes an inkjet spray method.

16. The method of claim 8, wherein a third thickness of each of the color filters is about 8/10 to about 10/10 of the sum of a first thickness of the black matrix shape and a second thickness of the barrier.

17. A color filter substrate for a liquid crystal display, comprising:
a transparent insulating substrate;
a black matrix shape on the transparent insulating substrate and having a first thickness;
a transparent barrier with the same shape as the black matrix shape and having a second thickness; and
color filters having a third thickness and positioned within the black matrix and the transparent barrier,
wherein the second thickness is at least as much as a difference between the first thickness and the third thickness.

18. The color filter substrate of claim 17, wherein the black matrix shape is formed of a black resin that absorbs light.

19. The color filter substrate of claim 17, wherein the first thickness is greater than the second thickness.

20. The color filter substrate of claim 17, wherein the third thickness is about 8/10 to about 10/10 of the sum of the first thickness and the second thickness.
